(19) United States
(12) Patent Application Publication
(10) Pub. No.: US 2023/0245878 A1
(43) Pub. Date: Aug. 3, 2023

(54) MASS SPECTROMETER

(71) Applicant: SHIMADZU CORPORATION, Kyoto-shi, Kyoto (JP)

(72) Inventors: Masaru NISHIGUCHI, Kyoto-shi (JP); Manabu SHIMOMURA, Kyoto-shi (JP)

(73) Assignee: SHIMADZU CORPORATION, Kyoto-shi, Kyoto (JP)

(21) Appl. No.: 18/015,891

(22) PCT Filed: Aug. 20, 2020
(86) PCT No.: PCT/JP2020/031514

§ 371 Date: Jan. 12, 2023

(51) Int. Cl. H01J 49/14; H01J 49/20

(52) U.S. Cl. CPC H01J 49/147; H01J 49/20

(57) ABSTRACT

A mass spectrometer includes an ion source including: an ionization chamber including an ion ejection hole, and an electron introduction port and an electron discharge port; a repeller electrode; a filament; a trap electrode; and a magnetic field forming unit. A first distance in a direction along the ion optical axis between an end of the electron introduction port on an ion ejection hole side and an inner face of a wall of the ionization chamber in which the ion ejection hole is formed and/or a second distance in a direction along the ion optical axis between an end of the electron introduction port on a repeller electrode side and the repeller electrode, is set to be larger than a radius of gyration of the thermal electron estimated based on energy imparted to the thermal electron and intensity of the magnetic field formed by the magnetic field forming unit.

### TECHNICAL FIELD

The present invention relates to a mass spectrometer, and, more specifically, relates to a mass spectrometer using an ion source by an electron ionization (EI) method, a chemical ionization (CI) method, or a negative chemical ionization (NCI) method.

### BACKGROUND ART

A mass spectrometer as a gas chromatograph mass spectrometer (GC-MS) mainly uses an ionization method such as an EI method, a CI method, or an NCI method to ionize a compound of sample gas. The compound in sample gas introduced into an ionization chamber disposed in a vacuum chamber is ionized by an appropriate ionization method as described above. Then, the generated ions are transported to a mass separation unit such as a quadrupole mass filter, and are separated according to a mass-to-charge ratio (strictly speaking, “m/z” in italics, but referred to as “mass-to-charge ratio” in the present description according to the conventional manner) and detected.

FIGS. 4A and 4B are schematic configuration diagrams of a conventional general EI ion source, wherein FIG. 4A is a schematic longitudinal end view, and FIG. 4B is a schematic top view (see Patent Literature 1 and the like). For convenience of explanation, three axes of X, Y, and Z orthogonal to each other are defined in the space as shown.

This ion source includes an ionization chamber 10 having a box shape, which is made of a conductive member, and a repeller electrode 14 having a plate shape is disposed inside the ionization chamber 10. An electron introduction port 102 is formed in an upper wall of the ionization chamber 10, an electron discharge port 103 is formed in a lower wall of the ionization chamber 10, a filament 11 is disposed outside the electron introduction port 102, and an opposing filament (substantially, a trap electrode) 12 is disposed outside the electron discharge port 103. A pair of focusing magnets 13 are disposed outside the filament 11 and the opposing filament 12 so as to sandwich them. An ion ejection hole 101 is formed in a front wall of the ionization chamber 10 (wall opposite to the wall on the side of which the repeller electrode 14 is disposed), and an ion lens 2 including extraction electrodes is disposed on the outside of the ion ejection hole 101. A sample gas introduction pipe 15 is connected to a side wall of the ionization chamber 10.

At the time of ionization, the filament 11 is energized to generate heat and generate thermal electrons. A direct current voltage having a predetermined potential difference is applied between the filament 11 and the opposing filament 12, and the generated thermal electrons are accelerated by the potential difference to move to the opposing filament 12. As a result, a thermal electron flow 16 advancing in the Y-axis direction is formed in the ionization chamber 10. A sample component (compound) in the sample gas supplied into the ionization chamber 10 through the sample gas introduction pipe 15 comes into contact with the thermal electrons and is ionized. The focusing magnets 13 form a magnetic field in which the magnetic flux lines run in the Y-axis direction, and the broadening of the thermal electron flow 16 in the X-axis and Z-axis directions is suppressed by the magnetic field.

A direct current voltage V1 having the same polarity as that of the ions derived from the sample is applied to the repeller electrode 14. As a result, an extrusion electric field having a force to push the ions in a direction away from the repeller electrode 14 is formed between the repeller electrode 14 and the ion ejection hole 101 in the ionization chamber 10. Due to the action of this electric field, the ions generated near the center of the ionization chamber 10 are pushed toward the ion ejection hole 101. Further, an extraction electric field formed by the voltage applied to the extraction electrodes of the ion lens 2 intrudes into the ionization chamber 10 through the ion ejection hole 101. Ions are extracted from the ionization chamber 10 in the X-axis direction by the actions of both the extrusion electric field and the extraction electric field.

In the configuration shown in FIGS. 4A and 4B, the filament 11 and the opposing filament 12 have a linear shape, and are arranged so as to extend in the Z-axis direction as shown in the drawing. That is, the filament 11 and the opposing filament 12 are arranged so as to be orthogonal to the X-axis which is the ion extraction direction. Here, such an arrangement is referred to as an orthogonal filament arrangement structure. Generally, this orthogonal filament arrangement structure is widely adopted.

On the other hand, FIG. 5 is a schematic top view of another ion source similar to that of FIG. 4B, and as shown in FIG. 5, there is also known a configuration in which the filament 11 and the opposing filament 12 are arranged in parallel with the X-axis which is the ion extraction direction (see Patent Literature 2 and the like). Here, such an arrangement is referred to as a parallel filament arrangement structure.

The parallel filament arrangement structure is advantageous in increasing the extraction efficiency of ions from the ionization chamber 10 as compared to the orthogonal filament arrangement structure. Therefore, the amount of ions to be subjected to the mass spectrometry can be increased, and thus, the parallel filament arrangement structure is advantageous for improving detection sensitivity. However, as compared with the orthogonal filament arrangement structure, the parallel filament arrangement structure has a problem of lacking measurement stability, such as a large ionic intensity drift and poor ionic intensity reproducibility. In this respect, although the orthogonal filament arrangement structure has lower sensitivity than the parallel filament arrangement structure, the orthogonal filament arrangement structure is excellent in balance between sensitivity and measurement stability. This is the main reason why the orthogonal filament arrangement structure is widely adopted.

### CITATION LIST

### Patent Literature

Patent Literature 1: JP 2016-157523 A
Patent Literature 2: JP 2000-48763 A

### SUMMARY OF INVENTION

### Technical Problem

As described above, the parallel filament arrangement structure is advantageous in increasing the sensitivity but is inferior in the measurement stability as compared with the orthogonal filament arrangement structure. If this matter is improved, the sensitivity of a mass spectrometer equipped with an EI ion source or the like can be improved, and it becomes possible to identify or quantify a very small amount of compounds in gas chromatograph mass spectrometry or the like.

The present invention has been developed to solve the previously described problem. Its objective is to provide a mass spectrometer including an EI ion source, a CI ion source, and the like capable of achieving both high sensitivity and high stability.

### Solution to Problem

One mode of a mass spectrometer according to the present invention to solve the above problem, is a mass spectrometer including an ion source configured to ionize a sample component contained in sample gas, wherein the ion source includes:

an ionization chamber which includes an ion ejection hole, and an electron introduction port and an electron discharge port which are disposed to face each other across an ion optical axis which is a central axis of an ion flow emitted from the ion ejection hole, and is configured to form a space substantially partitioned from the outside in the ionization chamber;

a repeller electrode disposed on the ion optical axis inside the ionization chamber and configured to form an electric field which extrudes ions generated in the ionization chamber to the outside through the ion ejection hole;

a filament disposed outside the electron introduction port in a manner of extending in the same direction as the ion optical axis;

a trap electrode disposed outside the electron discharge port; and

a magnetic field forming unit configured to form a magnetic field such as to control a trajectory of a thermal electron from the filament passing through the inside of the ionization chamber toward the trap electrode, and

wherein either one or both of: a first distance in a direction along the ion optical axis between an end of the electron introduction port on an ion ejection hole side and an inner face of a wall of the ionization chamber in which the ion ejection hole is formed; and a second distance in a direction along the ion optical axis between an end of the electron introduction port on a repeller electrode side and the repeller electrode, is set to be larger than a radius of gyration of the thermal electron estimated based on energy imparted to the thermal electron and intensity of the magnetic field formed by the magnetic field forming unit.

Another mode of the mass spectrometer according to the present invention to solve the above problem, is a mass spectrometer including an ion source configured to ionize a sample component contained in sample gas, wherein the ion source includes:

an ionization chamber which includes an ion ejection hole, and an electron introduction port and an electron discharge port which are disposed to face each other across an ion optical axis which is a central axis of an ion flow emitted from the ion ejection hole, and is configured to form a space substantially partitioned from the outside in the ionization chamber;

a repeller electrode disposed on the ion optical axis inside the ionization chamber and configured to form an electric field which extrudes ions generated in the ionization chamber to the outside through the ion ejection hole;

a filament disposed outside the electron introduction port in a manner of extending in the same direction as the ion optical axis;

a trap electrode disposed outside the electron discharge port; and

a magnetic field forming unit configured to form a magnetic field such as to control a trajectory of a thermal electron from the filament passing through the inside of the ionization chamber toward the trap electrode, and wherein either one or both of: a first distance in a direction along the ion optical axis between an end of the electron introduction port on an ion ejection hole side and an inner face of a wall of the ionization chamber in which the ion ejection hole is formed; and a second distance in a direction along the ion optical axis between an end of the electron introduction port on a repeller electrode side and the repeller electrode, is set to be equal to or greater than 1.2 mm.

### Advantageous Effects of Invention

The ion source of the mass spectrometer according to the present invention is an ion source that utilizes thermal electrons for ionization, and is specifically an ion source based on the EI method, the CI method, or the NCI method.

In the mass spectrometer according to the present invention, the thermal electrons emitted from the filament enter the ionization chamber through the electron introduction port, pass through the inner space of the ionization chamber, and reach the trap electrode through the electron discharge port. When the thermal electrons pass through the inner space of the ionization chamber, the thermal electrons fly while spirally turning due to the action of the magnetic field formed by the magnetic field forming unit. In the mass spectrometer according to the mode described above, the thermal electrons flying while spirally turning as described above are less likely to come into contact with the inner face of the wall of the ionization chamber where the ion ejection hole is formed and the repeller electrode. In addition, since ions are hardly generated in a region where thermal electrons do not exist or their density is low, the ions are also less likely to come into contact with the inner face of the wall of the ionization chamber where the ion ejection hole is formed and the repeller electrode.

According to the study of the present inventor, it is presumed that a major factor of poor measurement stability in the EI ion source having the parallel filament arrangement structure is disturbance of the electric field in the ionization chamber caused by contamination of the wall face of the ionization chamber or the repeller electrode. The main cause of such contamination is the attachment of thermal electrons and ions. According to the above mode of the mass spectrometer according to the present invention, thermal electrons and ions are less likely to come into contact with the inner face of the wall of the ionization chamber where the ion ejection hole is formed and the repeller electrode. Therefore, it is possible to reduce the contamination of the inner face of the wall of the ionization chamber and the repeller electrode, thereby improving the measurement stability. That is, it is possible to improve the measurement stability while making the most of the high sensitivity in the parallel filament arrangement structure, and it is possible to achieve both high sensitivity and high measurement stability.

The first distance is important when the influence of the extrusion electric field by the repeller electrode is dominant on the behavior of ions extracted from inside the ionization chamber to the outside through the ion ejection hole, and conversely, the second distance is important when the electric field (extraction electric field) in the vicinity of the ion ejection hole is dominant on the behavior of ions extracted from inside the ionization chamber to the outside through the ion ejection hole. Therefore, although which of the first and second distances has a greater influence on the performance (stability) of the mass spectrometer varies depending on the configuration of the mass spectrometer, by setting at least one of the first distance and the second distance as described above, the stability of the mass spectrometer can be reliably improved as compared with conventional mass spectrometers.

### BRIEF DESCRIPTION OF DRAWINGS

FIG. 1A is a schematic longitudinal end view of an EI ion source in a mass spectrometer according to an embodiment of the present invention, and FIG. 1B is a schematic top view of an EI ion source in a mass spectrometer according to an embodiment of the present invention.

FIG. 2 is a schematic overall configuration diagram of the mass spectrometer of the present embodiment.

FIG. 3 is an explanatory diagram of a structural difference between the EI ion source in the mass spectrometer of the present embodiment and a conventional EI ion source.

FIG. 4A is a schematic longitudinal end view of an EI ion source having an orthogonal filament arrangement structure in a conventional general mass spectrometer, and FIG. 4B is a schematic top view of an EI ion source having an orthogonal filament arrangement structure in a conventional general mass spectrometer.

FIG. 5 is a schematic top view of an EI ion source having a parallel filament arrangement structure in a conventional general mass spectrometer.

### DESCRIPTION OF EMBODIMENTS

A mass spectrometer according to an embodiment of the present invention will be described with reference to the accompanying drawings.

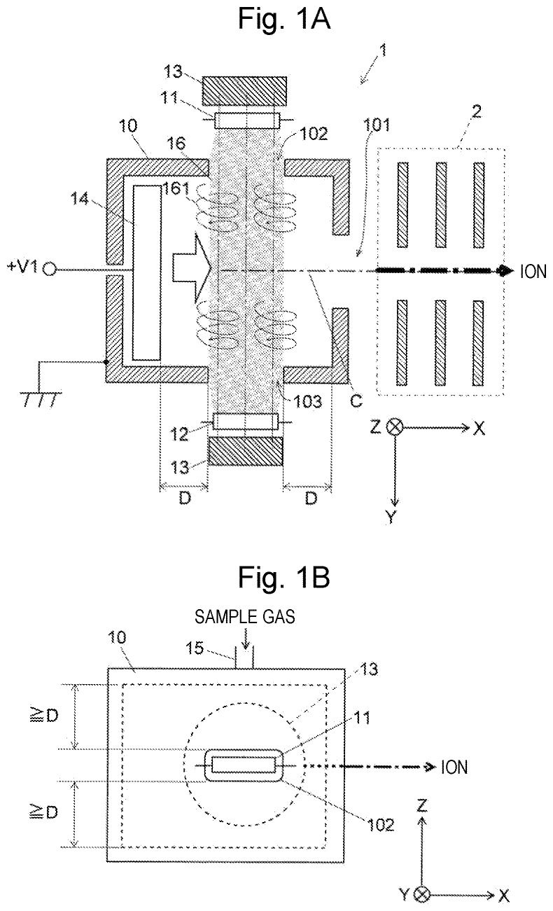

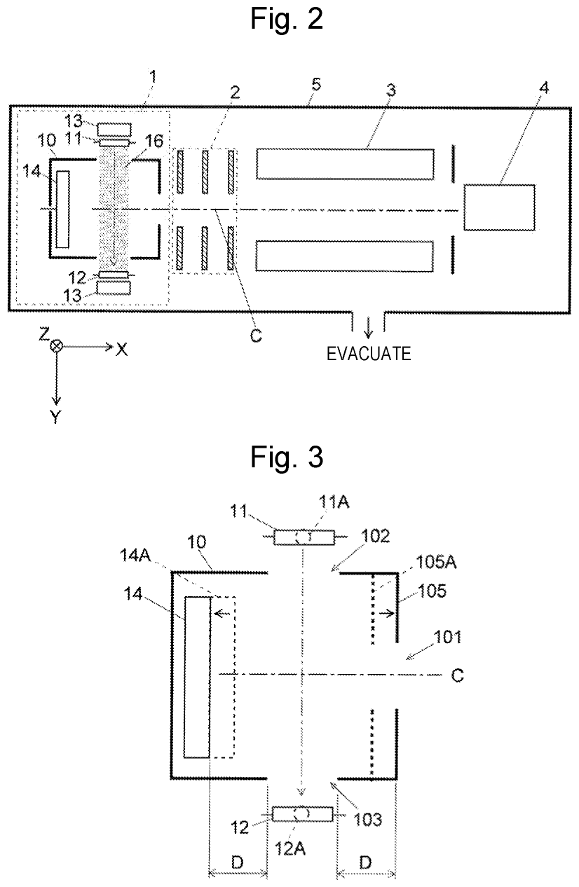

FIG. 2 is a schematic overall configuration diagram of the mass spectrometer of the present embodiment. FIG. 1A is a schematic longitudinal end view of an EI ion source in the mass spectrometer according to the present embodiment, and FIG. 1B is a schematic top view of an EI ion source in the mass spectrometer according to the present embodiment. The mass spectrometer of the present embodiment is a single quadrupole mass spectrometer.

As shown in FIG. 2, the mass spectrometer of the present embodiment includes an EI ion source 1, an ion lens 2, a quadrupole mass filter 3 as a mass separator, and an ion detector 4 in a chamber 5 evacuated by a vacuum pump (not shown).

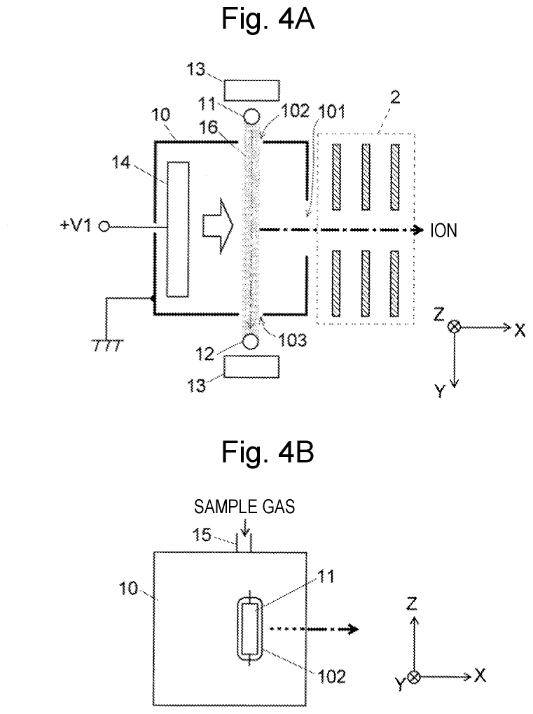

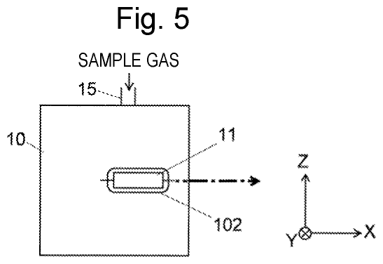

The EI ion source 1 is an ion source having a parallel filament arrangement structure similar to that shown in FIG. 5. The EI ion source 1 includes: an ionization chamber 10 that has a substantially rectangular parallelepiped outer shape and made of a conductive material such as metal; a repeller electrode 14 that is disposed inside the ionization chamber 10; a filament 11 that is disposed outside an electron introduction port (opening size: 2×4 mm) 102 formed in the ionization chamber 10; an opposing filament 12 disposed as a trap electrode outside an electron discharge port (opening size: 2×4 mm) 103 formed opposite to the electron introduction port 102; and a pair of focusing magnets 13 disposed in a manner of sandwiching the filament 11 and the opposing filament 12. A sample gas introduction pipe 15 is connected to a side wall of the ionization chamber 10. The ionization chamber 10 is grounded, and its direct current potential is maintained at 0 V. In FIGS. 1 and 2, the size of each component, the interval between a plurality of components, and the like do not reflect actual dimensions. In addition, in the EI ion source 1, each component except the ionization chamber 10 may be the same as that used in the conventional EI ion source shown in FIGS. 4 and 5.

A mass spectrometric operation in the mass spectrometer of the present embodiment will be schematically described.

For example, sample gas containing a sample component temporally separated in a column of a gas chromatograph (not shown) is introduced into the ionization chamber 10 through the sample gas introduction pipe 15. An electric current is supplied to the filament 11 from a power source (not shown), thereby the filament 11 is heated to generate thermal electrons. Energy is imparted to the thermal electrons by the potential difference between the filament 11 and the opposing filament 12, and the thermal electrons advance toward the opposing filament 12. That is, a thermal electron flow 16 directed from the filament 11 to the opposing filament 12 is formed. The thermal electron flow 16 is substantially parallel to the Y-axis direction. In general, the energy imparted to the thermal electrons is normally 70 eV.

The sample component in the sample gas comes into contact with the thermal electrons and is ionized. A predetermined direct current voltage +V1 is applied to the repeller electrode 14, and an electric field formed by the voltage has an action of extruding the ions (positive ions) generated as described above substantially in the X-axis direction, that is, in a direction toward the ion ejection hole 101. A direct current voltage having a polarity opposite to that of the ions is applied to the extraction electrodes of the ion lens 2 closest to the EI ion source 1, and an extraction electric field generated by the extraction electrodes extends into the ionization chamber 10 through the ion ejection hole 101. This electric field has an action of attracting ions. As a result, the ions generated in the ionization chamber 10 are extracted to the outside through the ion ejection hole 101 and introduced into the ion lens 2. The central axis of this ion flow is an ion optical axis C.

In the ion lens 2, the ions are once focused in the vicinity of the ion optical axis C, further accelerated, and sent to the quadrupole mass filter 3. A predetermined voltage obtained by adding a radio-frequency voltage (RF voltage) to a direct current voltage is applied to four rod electrodes constituting the quadrupole mass filter 3, and only ions having a specific mass-to-charge ratio corresponding to the voltage selectively pass through the quadrupole mass filter 3. The ion detector 4 generates and outputs a detection signal corresponding to the amount of the ions that have arrived. Therefore, for example, by controlling the applied voltage such that the mass-to-charge ratio of the ions passing through the quadrupole mass filter 3 changes within a predetermined range, mass spectrum data indicating the ionic intensity in the predetermined mass-to-charge ratio range can be obtained.

In the EI ion source 1, the sizes of the electron introduction port 102 formed in the upper wall of the ionization chamber 10 and the electron discharge port 103 formed in the lower wall of the ionization chamber 10 are slightly larger than the outer shape of the filament 11 (and the opposing filament 12) and have an elongated shape in the X-axis direction, as shown in FIG. 1B. Among the thermal electrons emitted from the filament 11, the thermal electrons reaching the electron introduction port 102 at an angle within a predetermined angle with respect to the Y-axis pass through the electron introduction port 102. Therefore, when the magnetic field formed by the focusing magnets 13 does not exist, the thermal electrons that have passed through the electron introduction port 102 spread in the X-axis direction and the Z-axis direction. Since the magnetic field formed by the focusing magnets 13 has an action of suppressing the spread of the thermal electrons and the direction of the magnetic flux lines in the magnetic field is substantially parallel to the Y-axis, the thermal electrons advance in the Y-axis direction while spirally turning as shown in FIGS. 1 and 2. This increases the chances of contact between the sample molecules and the thermal electrons and improves the efficiency of ionization.

On the other hand, when the thermal electrons come into contact with the inner wall face of the ionization chamber 10 or come into contact with and adhere to the repeller electrode 14, the thermal electrons become a cause of contamination of the inner wall face and the repeller electrode 14. Since the ions derived from the sample component are generated in the region where the thermal electrons exist, when the thermal electrons exist close to the repeller electrode 14 or the inner face of the wall of the ionization chamber 10, the generated ions are also likely to come into contact with the repeller electrode 14 or the inner face of the wall of the ionization chamber 10. This also causes contamination. When the inner face of the wall of the ionization chamber 10 or the repeller electrode 14 is contaminated, disturbance occurs in the electric field formed inside the ionization chamber 10 due to the contamination, and the extraction efficiency of ions from the inside of the ionization chamber 10 decreases or the extraction of ions becomes unstable. As a result, the amount of ions sent to the quadrupole mass filter 3 decreases, leading to a decrease in detection sensitivity. Therefore, in the EI ion source 1 of the mass spectrometer of the present embodiment, a structural contrivance is made such that the thermal electrons which have entered the ionization chamber 10 are less likely to come into contact with the repeller electrode 14 and the inner face of the wall of the ionization chamber 10.

FIG. 3 is a schematic diagram for explaining a structural difference between the EI ion source according to the present embodiment and a conventional EI ion source. In FIG. 3, reference signs 11A and 12A indicate the positions of the filament and the opposing filament in the orthogonal filament arrangement structure described in FIGS. 4A and 4B. In this case, the filament and the opposing filament are arranged so as to extend in the Y-axis direction. A reference sign 105A indicates the position of the front wall of the ionization chamber 10 in the orthogonal filament arrangement structure and a reference sign 14A indicates the position of the repeller electrode in the orthogonal filament arrangement structure. In the orthogonal filament arrangement structure, when the thermal electrons emitted from the filament 11A spirally turn and expand outward, the thermal electrons also hardly contact with the repeller electrode 14A or the inner side of the front wall 105A of the ionization chamber 10.

On the other hand, when the orthogonal filament arrangement structure is changed to the parallel filament arrangement structure such as to improve the detection sensitivity, the orientations of the filament 11 and the opposing filament 12 are changed to extend in the X-axis direction, and the electron introduction port 102 and the electron discharge port 103 are also changed to extend in the Z-axis direction. This is the structure shown in FIG. 5. However, since the arrangement of the filament 11 and the shape of the electron introduction port 102 are changed to extend in the X-axis direction, the distance (first distance) in the X-axis direction between the end of the electron introduction port 102 on the ion ejection hole 101 side and the inner face of the front wall 105A of the ionization chamber 10 and the distance (second distance) in the X-axis direction between the end of the electron introduction port 102 on the repeller electrode 14 side and the surface of the repeller electrode 14A become short. As a result, when the thermal electrons emitted from the filament 11A spirally turn and expand outward, the thermal electrons easily come into contact with the inner side of the front wall 105A of the ionization chamber 10 or the repeller electrode 14A.

Therefore, in the mass spectrometer of the present embodiment, the front wall 105 of the ionization chamber 10 is extended to the front side (in the positive direction of the X-axis) and the position of the repeller electrode 14 is retracted in the negative direction of the X-axis such that both the first distance and the second distance are also about the same as those in the orthogonal filament arrangement structure after changing to the parallel filament arrangement structure. Of course, for this purpose, the rear wall of the ionization chamber 10 is also widened to the rear side. In the mass spectrometer of the present embodiment, both the first distance and the second distance are D. The value of D may be determined, for example, as follows.

What mainly affects the spread of the thermal electron flow 16 in the X-axis direction (ion extraction direction) is the radius of gyration of the thermal electrons. Factors related to the radius of gyration are the geometrical structure such as the size of the electron introduction port 102, the energy of the thermal electrons which mainly depends on the potential difference between the filament 11 and the opposing filament 12, and the intensity of the magnetic field formed by the focusing magnets 13. The geometrical structure is structurally determined, and the energy of the thermal electrons is determined by the control conditions of the voltage control. Therefore, if the velocity component and the magnetic flux density in the direction perpendicular to the magnetic field formed by the focusing magnets 13 (i.e., on the X-Z plane) are known, the radius of gyration of the thermal electrons can be estimated based on the Lorentz force, and the degree of spreading of the thermal electron flow 16 inside the ionization chamber 10 can be estimated.

The velocity component of the thermal electrons in the direction perpendicular to the magnetic field depends on the angle at which the thermal electrons are emitted from the surface of the filament 11 and pass through the electron introduction port 102 while being accelerated. This movement of the thermal electrons is a movement under the influence of a strong magnetic field in the vicinity of the focusing magnets 13, and there is a possibility that thermal electrons having a large angle also enter the ionization chamber 10 while gyrating. Therefore, here, as a typical example, thermal electrons which enter at an angle θ=π/4 with respect to the magnetic flux lines, that is, the Y-axis are assumed. Assuming that the accelerating voltage of the thermal electron is V and the mass of the thermal electron is mₑ, a velocity component νᵥ in the direction perpendicular to the magnetic field in the vicinity of the center of the ionization chamber 10 (in the vicinity of the ion optical axis C) is expressed by the following equation (1).

νᵥ=√(2 eV/mₑ)sin θ=√(eV/mₑ) (1)

The radius of gyration rₑ of an electron in a magnetic field having a magnetic flux density B is expressed by the following equation (2).

rₑ=(mₑνᵥ)/eB=√{(mₑV)/(eB²)} (2)

As an example of the focusing magnets 13 generally used in the EI ion source, it is assumed that B is about 0.02 T at a portion where the magnetic flux density is the weakest in the vicinity of the center of the ionization chamber 10. The energy of each electron is assumed to be 70 eV which is the standard ionization energy in the EI ion source. Under this condition, based on the equations (1) and (2), the radius of gyration rₑ of the thermal electrons is calculated to be about rₑ=1 mm Therefore, a measure of the minimum values of the first distance and the second distance may be set to 1 mm.

However, this is based on the assumption that the thermal electrons which are emitted from the filament 11 and reach the opposing filament 12 advance as a whole, that is, advance in the Y-axis direction when the central axis of gyration is considered, but actually, it is also conceivable that the advancing direction of the thermal electrons is expanded outward. Therefore, at least the safety factor may be set to 1.2, and the first distance and the second distance may be set to be equal to or greater than 1.2 mm. It is also preferable to assume that there is a variation in the magnetic field intensity of the focusing magnets 13 or that the entering angle of the thermal electrons into the ionization chamber 10 is somewhat larger than the above value. For this reason, the safety factor may be set to a larger value of 1.5, and the first distance and the second distance may be set to be equal to or greater than 1.5 mm. Furthermore, when the user can freely set the energy of each electron, it is necessary to consider a case where the energy is equal to or higher than 70 eV. In this case, the safety factor may be set to a larger value of 2, and the first distance and the second distance may be set to be equal to or greater than 2 mm.

On the other hand, as the first distance and the second distance are increased, the contamination caused by the collision of the thermal electrons and the ions can be reduced and the measurement stability can be enhanced, however, since the ion generation position in the ionization chamber 10 and the ion ejection hole 101 are separated from each other, it becomes difficult to efficiently extract the ions from the ionization chamber 10. The first distance and the second distance may be set to be equal to or less than about 3 mm in order to realize higher sensitivity than that of the orthogonal filament arrangement structure while setting the voltage applied to the extraction electrodes and the voltage applied to the repeller electrode 14 to the same values as those of a conventional general EI ion source. As described above, it is necessary to comprehensively determine the first distance and the second distance, that is, the value of D in terms of both detection sensitivity and measurement stability. Of course, the first distance and the second distance may be different from each other, for example, one may be 2 mm and the other may be 1.5 mm.

As shown in FIG. 1B, in the EI ion source 1 of the mass spectrometer according to the present embodiment, the distance between the inner face of the side wall of the ionization chamber 10 and the end of the electron introduction port 102 is normally ensured to be equal to or greater than the above distance D. Therefore, the thermal electrons and ions are less likely to collide with the inner face of the side wall of the ionization chamber 10.

As described above, in the mass spectrometer of the present embodiment, while improving the detection sensitivity by efficiently extracting ions from the ionization chamber 10 in the EI ion source 1, it is possible to reduce contamination of the inner wall of the ionization chamber 10 and the repeller electrode 14 due to thermal electrons and ions derived from sample components, thereby improving measurement stability and measurement reproducibility.

In the mass spectrometer of the above-described embodiment, both the first distance and the second distance are set to be equal to or greater than the predetermined distance D, but one of the first distance and the second distance may be set to be equal to or greater than the predetermined distance D. That is, when the influence of the extrusion electric field by the repeller electrode 14 is dominant on the behavior of the ions extracted from the inside of the ionization chamber 10 to the outside through the ion ejection hole 101, the density of the ions generated through contacting with the thermal electrons tends to be biased to the ion ejection hole 101 side. Therefore, the distance on the ion ejection hole 101 side, that is, the first distance is relatively more important. On the other hand, when the electric field (extraction electric field) in the vicinity of the ion ejection hole 101 is dominant on the behavior of ions, the density of the ions generated through contacting with the thermal electrons tends to spread toward the back side (side close to the repeller electrode 14) when viewed from the ion ejection hole 101. Therefore, the second distance is relatively more important. Therefore, depending on the configuration of the mass spectrometer, it is possible to reliably improve the stability of the mass spectrometer as compared with a conventional mass spectrometer by setting not both of the first distance and the second distance but one of them to be equal to or greater than D as described above.

The ion source having the above-described structure may be applied not only to an EI ion source but also to an ion source based on another ionization method using thermal electrons, specifically, a CI ion source or an NCI ion source.

The previous embodiment is one example of the present invention, and any modification, change, or addition appropriately made within the spirit of the present invention will evidently fall within the scope of claims of the present application.

[Various Modes]

It is evident for a person skilled in the art that the previously described illustrative embodiment is a specific example of the following modes of the present invention.

(Clause 1) One mode of a mass spectrometer according to the present invention, is a mass spectrometer including an ion source configured to ionize a sample component contained in sample gas, wherein the ion source includes:

an ionization chamber which includes an ion ejection hole, and an electron introduction port and an electron discharge port which are disposed to face each other across an ion optical axis which is a central axis of an ion flow emitted from the ion ejection hole, and is configured to form a space substantially partitioned from the outside in the ionization chamber;

a repeller electrode disposed on the ion optical axis inside the ionization chamber and configured to form an electric field which extrudes ions generated in the ionization chamber to the outside through the ion ejection hole;

a filament disposed outside the electron introduction port in a manner of extending in the same direction as the ion optical axis;

a trap electrode disposed outside the electron discharge port; and

a magnetic field forming unit configured to form a magnetic field such as to control a trajectory of a thermal electron from the filament passing through the inside of the ionization chamber toward the trap electrode, and

wherein either one or both of: a first distance in a direction along the ion optical axis between an end of the electron introduction port on an ion ejection hole side and an inner face of a wall of the ionization chamber in which the ion ejection hole is formed; and a second distance in a direction along the ion optical axis between an end of the electron introduction port on a repeller electrode side and the repeller electrode, is set to be larger than a radius of gyration of the thermal electron estimated based on energy imparted to the thermal electron and intensity of the magnetic field formed by the magnetic field forming unit.

(Clause 2) Another mode of the mass spectrometer according to the present invention, is a mass spectrometer including an ion source configured to ionize a sample component contained in sample gas, wherein the ion source includes:

an ionization chamber which includes an ion ejection hole, and an electron introduction port and an electron discharge port which are disposed to face each other across an ion optical axis which is a central axis of an ion flow emitted from the ion ejection hole, and is configured to form a space substantially partitioned from the outside in the ionization chamber;

a repeller electrode disposed on the ion optical axis inside the ionization chamber and configured to form an electric field which extrudes ions generated in the ionization chamber to the outside through the ion ejection hole;

a filament disposed outside the electron introduction port in a manner of extending in the same direction as the ion optical axis;

a trap electrode disposed outside the electron discharge port; and

a magnetic field forming unit configured to form a magnetic field such as to control a trajectory of a thermal electron from the filament passing through the inside of the ionization chamber toward the trap electrode, and

wherein either one or both of: a first distance in a direction along the ion optical axis between an end of the electron introduction port on an ion ejection hole side and an inner face of a wall of the ionization chamber in which the ion ejection hole is formed; and a second distance in a direction along the ion optical axis between an end of the electron introduction port on a repeller electrode side and the repeller electrode, is set to be equal to or greater than 1.2 mm.

According to the mass spectrometer described in Clause 1 or Clause 2, the thermal electrons and the ions are less likely to come into contact with the repeller electrode and the inner face of the wall of the ionization chamber in which the ion ejection hole is formed. Therefore, it is possible to reduce the contamination of the inner face of the wall of the ionization chamber and the repeller electrode, thereby stabilizing the electric field formed in the ionization chamber and improving the measurement stability. That is, it is possible to improve the measurement stability while making the most of the high detection sensitivity in the parallel filament arrangement structure, and it is possible to achieve both high sensitivity and high measurement stability.

(Clause 3) In the mass spectrometer according to Clause 1 or Clause 2, both the first distance and the second distance may be set to be equal to or greater than 1.5 mm.

(Clause 4) In the mass spectrometer according to Clause 3, both the first distance and the second distance may be set to be equal to or greater than 2 mm.

According to the mass spectrometers described in Clause 3 and Clause 4, for example, when there is a variation in the intensity of the magnetic field formed by the magnetic field forming unit or a change in the energy imparted to the electrons, etc., it is also possible to prevent the thermal electrons or ions from coming into contact with the inner face of the wall of the ionization chamber in which the ion ejection hole is formed or the repeller electrode. Thus, high sensitivity and high measurement stability can be more reliably achieved.

(Clause 5) In the mass spectrometer according to any one of Clause 2 to Clause 4, both the first distance and the second distance may be set to be equal to or less than 3 mm. That is, the first distance and the second distance may be set in any range of 1.2 to 3 mm, 1.5 to 3 mm, or 2 to 3 mm.

According to the mass spectrometer described in Clause 5, the extraction electric field can be sufficiently applied to the ions generated in the ionization chamber to efficiently extract the ions to the outside of the ionization chamber and introduce the ions into, for example, a mass separator or the like in the next stage. This makes it possible to reliably achieve high sensitivity while improving measurement stability.

(Clause 6) In the mass spectrometer according to any one of Clause 1 to Clause 5, the ion source may be configured to perform ionization based on an electron ionization method.

According to the mass spectrometer described in Clause 6, it is possible to efficiently ionize a component of sample gas, generate fragment ions by further cleaving a part of the component, and obtain a result of mass spectrometry of the fragment ions.

### REFERENCE SIGNS LIST

1 . . . EI Ion Source
10 . . . Ionization Chamber
101 . . . Ion Ejection Hole
102 . . . Electron Introduction Port
103 . . . Electron Discharge Port
105 . . . Front Wall
11 . . . Filament
12 . . . Opposing Filament
13 . . . Focusing Magnet
14 . . . Repeller Electrode
15 . . . Sample Gas Introduction Pipe
16 . . . Thermal Electron Flow
2 . . . Ion Lens
3 . . . Quadrupole Mass Filter
4 . . . Ion Detector
5 . . . Chamber
C . . . Ion Optical Axis

1. A mass spectrometer comprising an ion source configured to ionize a sample component contained in sample gas, wherein the ion source includes:
an ionization chamber which includes an ion ejection hole, and an electron introduction port and an electron discharge port which are disposed to face each other across an ion optical axis which is a central axis of an ion flow emitted from the ion ejection hole, and is configured to form a space substantially partitioned from an outside in the ionization chamber;
a repeller electrode disposed on the ion optical axis inside the ionization chamber and configured to form an electric field which extrudes ions generated in the ionization chamber to the outside through the ion ejection hole;
a filament disposed outside the electron introduction port in a manner of extending in a same direction as the ion optical axis;
a trap electrode disposed outside the electron discharge port; and
a magnetic field forming unit configured to form a magnetic field such as to control a trajectory of a thermal electron from the filament passing through the inside of the ionization chamber toward the trap electrode, and
wherein either one or both of: a first distance in a direction along the ion optical axis between an end of the electron introduction port on an ion ejection hole side and an inner face of a wall of the ionization chamber in which the ion ejection hole is formed; and a second distance in a direction along the ion optical axis between an end of the electron introduction port on a repeller electrode side and the repeller electrode, is set to be larger than a radius of gyration of the thermal electron estimated based on energy imparted to the thermal electron and intensity of the magnetic field formed by the magnetic field forming unit.

2. A mass spectrometer comprising an ion source configured to ionize a sample component contained in sample gas, wherein the ion source includes:
an ionization chamber which includes an ion ejection hole, and an electron introduction port and an electron discharge port which are disposed to face each other across an ion optical axis which is a central axis of an ion flow emitted from the ion ejection hole, and is configured to form a space substantially partitioned from an outside in the ionization chamber;
a repeller electrode disposed on the ion optical axis inside the ionization chamber and configured to form an electric field which extrudes ions generated in the ionization chamber to the outside through the ion ejection hole;
a filament disposed outside the electron introduction port in a manner of extending in a same direction as the ion optical axis;
a trap electrode disposed outside the electron discharge port; and
a magnetic field forming unit configured to form a magnetic field such as to control a trajectory of a thermal electron from the filament passing through the inside of the ionization chamber toward the trap electrode, and
wherein either one or both of: a first distance in a direction along the ion optical axis between an end of the electron introduction port on an ion ejection hole side and an inner face of a wall of the ionization chamber in which the ion ejection hole is formed; and a second distance in a direction along the ion optical axis between an end of the electron introduction port on a repeller electrode side and the repeller electrode, is set to be equal to or greater than 1.2 mm.

3. The mass spectrometer according to claim 2, wherein both the first distance and the second distance are equal to or greater than 1.5 mm.

4. The mass spectrometer according to claim 3, wherein both the first distance and the second distance are equal to or greater than 2 mm.

5. The mass spectrometer according to claim 4, wherein both the first distance and the second distance are equal to or less than 3 mm.

6. The mass spectrometer according to claim 1, wherein the ion source is configured to ionization based on an electron ionization method.

7. The mass spectrometer according to claim 2, wherein the ion source is configured to perform ionization based on an electron ionization method.
